(19) United States
(12) Patent Application Publication
(10) Pub. No.: US 2008/0240477 A1
(43) Pub. Date: Oct. 2, 2008

(54) Wireless multiple input hearing assist device

(76) Inventors: Robert Howard, New York, NY (US); Henry Smith, Bristol, PA (US)

Correspondence Address: AMSTER, ROTHSTEIN & EBENSTEIN LLP, 90 PARK AVENUE, NEW YORK, NY, 10016, US

(21) Appl. No.: 11/731,310

(22) Filed: Mar. 30, 2007

(51) Int. Cl. H04R 25/00

(52) U.S. Cl. 381/315; 381/320

(57) ABSTRACT

A wireless hearing assist device including a microphone unit and a receiver unit. The microphone unit includes a microphone that receives audio signals, a frequency profile adjustment control circuit that adjusts frequency profile of the received audio signals based on input by a user, and a transmitter that wirelessly transmits the adjusted audio signals. The receiver unit is adapted to be worn by the user and includes a receiver that wirelessly receives the adjusted audio signals transmitted by the transmitter, and a speaker that generates sound based on the adjusted audio signals. In at least one embodiment, the microphone unit includes a Bluetooth enabled RF communication link for wireless communication with an external device other than the receiver unit.

### FIELD OF THE INVENTION

The present disclosure relates to hearing assist devices for enhancing the hearing of a user.

### BACKGROUND OF THE INVENTION

Conventional one-piece devices to assist the hearing impaired are usually worn in or about the ear and consist of a microphone to receive audible sound, an amplifier that amplifies the sound and a transducer that delivers the sound to the user's ear. Acoustic coupling between the microphone and the transducer frequently results in squealing or feedback when operated at the high amplification levels required for individuals with mild to severe hearing impairments. The squealing is often an annoyance to hearing aid users.

Further, conventional hearing assist devices do not allow the user to independently control the various frequency characteristics of the sound provided to the user. In particular, a conventional hearing aid must be adjusted by a technician so that the frequency response curves of the hearing aid is matched to the needs of the user according to a hearing test. The lack of the user's ability to control the sound characteristics from time to time limits the use of known hearing aids to only those sound environments which at least resemble the sound environment to which the hearing aid is adjusted. Thus, for example, if the user is in an environment in which there is a lot of ambient noise, the user may have difficulty hearing human voices, unless the hearing aid was adjusted for such an environment.

Another problem associated with conventional hearing aids is that the battery must be frequently changed. Conventional hearing aids are designed to be placed within the user's ear, so that they can only be made up to a certain size and weight, thereby limiting the size of the battery that can be used to power the hearing aid. The relatively small batteries used in conventional hearing aids are drained quickly because they must power both the microphone and the transducer, which are incorporated in the same device. Further, the limitation on battery power in an ear worn device may limit the use of wireless connections with other devices.

Accordingly, there is a need for a hearing assist device that does not exhibit the problems associated with conventional hearing assist devices, such as feedback at high amplitudes and short battery life, while also allowing a user to adjust the sound characteristics produced by the hearing assist device in varying sound environments.

### SUMMARY OF THE INVENTION

A wireless hearing assist device according to an exemplary embodiment of the present invention includes a microphone unit and a receiver unit. The microphone unit includes a microphone that receives audio signals from a plurality of sources, a frequency profile adjustment control circuit that adjusts frequency profile of the received audio signals based on input by a user, and a transmitter that wirelessly transmits the adjusted audio signals. The receiver unit is adapted to be worn by the user and includes a receiver that wirelessly receives the adjusted audio signals transmitted by the transmitter, and a speaker that generates sound based on the adjusted audio signals.

A wireless hearing assist device according to another exemplary embodiment of the present invention includes a microphone unit and a receiver unit. The microphone unit includes a microphone that receives audio signals from a plurality of sources, a transmitter that wirelessly transmits the audio signals, and a Bluetooth enabled RF communication link for wireless communication with a device external to the wireless hearing assist device. The receiver unit is adapted to be worn by the user and includes a receiver that wirelessly receives the audio signals transmitted by the transmitter, and a speaker that generates sound based on the audio signals.

These and other features of this invention are described in, or are apparent from, the following detailed description of various exemplary embodiments of this invention.

### BRIEF DESCRIPTION OF THE FIGURES

Various exemplary embodiments of the invention will be described in detail, with reference to the following figures, wherein:

FIG. 1 shows a hearing assist device according to an exemplary embodiment of the present invention;

FIG. 2 is a side view of the hearing assist device of FIG. 1;

FIG. 3 is a block diagram illustrating the internal components of a microphone unit according to an exemplary embodiment of the present invention;

FIG. 4 is a block diagram illustrating the internal components of a receiver unit according to an exemplary embodiment of the present invention;

FIG. 5 is a block diagram illustrating the internal components of a microphone unit according to another exemplary embodiment of the present invention;

FIG. 6 shows a hearing assist device according to another exemplary embodiment of the present invention;

FIG. 7 shows a hearing assist device according to another exemplary embodiment of the present invention;

FIG. 8 is a plan view of a microphone unit according to another exemplary embodiment of the present invention;

FIG. 9 is a perspective view of the microphone unit of FIG. 8;

FIG. 10 is a side view of the microphone unit of FIG. 8;

FIG. 11 is a top view of the microphone unit of FIG. 8;

FIG. 12 shows a receiver unit according to an exemplary embodiment of the present invention worn by a user;

FIG. 13 is a block diagram of the receiver unit of FIG. 12; and

FIG. 14 shows a portion of the receiver unit of FIG. 12 attached to a user's ear.

### DETAILED DESCRIPTION OF PREFERRED EMBODIMENTS

Various exemplary embodiments of the present invention are directed to a wireless hearing assist device including a receiver unit in remote communication with a microphone unit. The term “hearing assist device” as used herein is not intended to be limited to devices for persons who are hearing impaired. Instead, the term “hearing assist device” is intended to apply to devices according to the present inventive teachings and may be used by any person seeking to obtain the benefits described below. Accordingly, the hearing assist device described herein may take many forms in which a speaker is placed within or adjacent the ear canal to improve the user's hearing in a variety of environments. Moreover, the hearing assist device according to the present invention may be part of a headset device which also performs other functionality, such as a communicating headset or an entertainment headset.

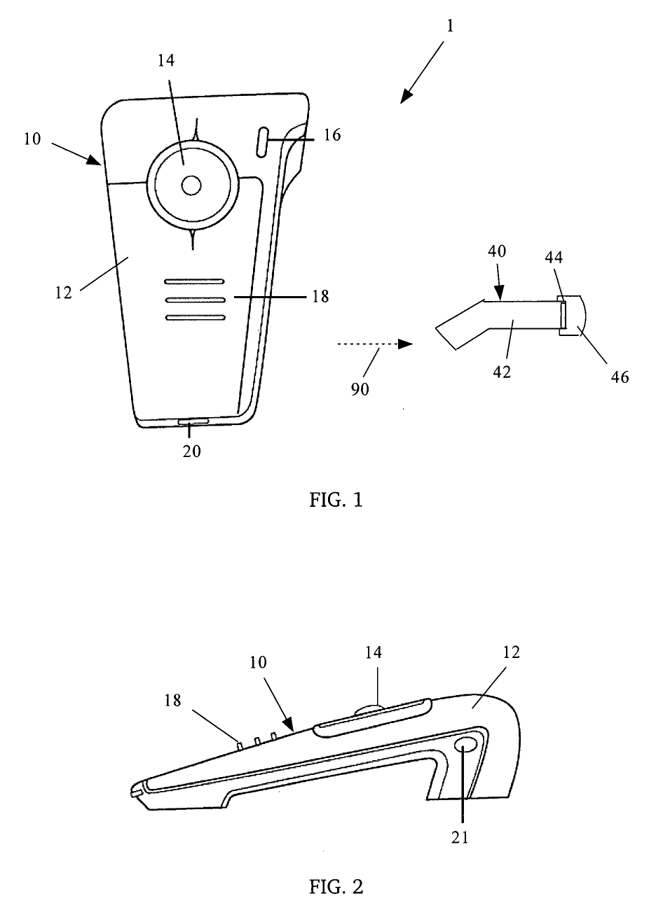

FIG. 1 shows a hearing assist device, generally designated by reference number 1, according to an exemplary embodiment of the present invention. The hearing assist device 1 includes a microphone unit, generally designated by reference number 10, in remote wireless communication (as shown by dashed arrows 90) with a receiver unit, generally designated by reference number 40. The microphone unit 10 receives and processes sound signals from multiple sources, and sends the signals to the receiver unit 40, which is preferably designed to be held in place within a user's ear canal. As discussed in further detail below, the receiver unit 40 includes a speaker that produces sound within the user's ear based on the sound signals received from the microphone unit 10. In use, the microphone unit 10 may be placed on a table in front of the user, so that the microphone unit 10 may receive sound signals from a variety of sources within a room or other environment. Alternatively, the microphone unit 10 may simply be held in the user's hand or be clipped onto a belt worn by the user. Although only one receiver unit 40 is shown in FIG. 1, it should be appreciated that the receiver unit 40 may include a pair of components, one for each ear of the user, thus enabling sound to be presented to the user in stereo.

The microphone unit 10 has an outer casing 12 forming a unitary structure. The outer casing 12 is preferably formed of a rigid material, such as, for example, metal or plastic, to house and protect internal components as well as to present a sleek and ergonomic design. The microphone unit 10 includes a microphone 14 that is capable of receiving multiple sound inputs, and a variety of controls, such as volume control 16, graphic equalizer 18 and balance control 20 (for a dual component receiver unit 40) exposed through the outer casing 12 for easy access by a user. The microphone 14 may be directionally sensitive, so that it exhibits improved functionality when facing in a particular direction relative to the sound source. As described in more detail below, the controls allow a user to adjust the sound signals sent to the receiver unit 40 from the microphone unit 10 as the user moves from one sound environment to another. Thus, the user is able to adjust the hearing assist device 1 “on the fly”, as opposed to conventional hearing aids which require specialized and often expensive recalibration by a technician or other external equipment. As shown in FIG. 2, which is a side view of the microphone unit 10, the microphone unit 10 also includes an on/off switch 21 exposed through a side wall of the outer casing 12.

The receiver unit 40 includes a housing 42, at least a portion of which is preferably made of a flexible material, such as, for example, polyvinyl chloride or other suitable materials which allow the receiver unit 40 to be deformed to the curvature of the user's outer ear. In this regard, bendable wires (not shown) may be positioned within the housing 42 to maintain the desired shape of the receiver unit 40 upon deformation. The receiver unit 40 also includes a speaker 44 that produces sound waves based on the signals generated by the microphone unit 10. The speaker 44 is preferably disposed at a distal end portion of the receiver unit 40, so that it is positioned directly adjacent to or within the ear canal when the receiver unit 40 is worn by the user. In this regard, the receiver unit 40 may be a behind the ear (BTE) type, an in the ear (ITE) type or an in the canal (ITC) type. A replaceable tip 46 may be disposed over the distal end of the receiver unit 40 for improved hygiene and/or comfort.

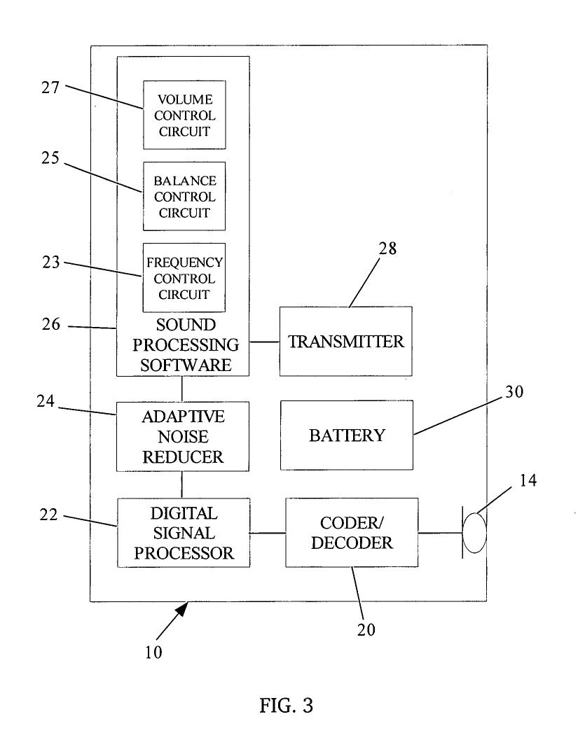

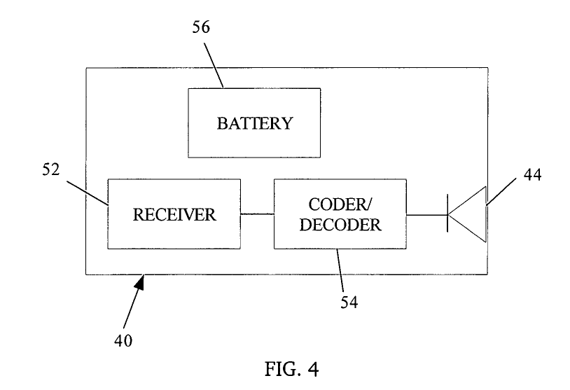

FIG. 3 is a block diagram illustrating the internal components of the microphone unit 10. The microphone unit 10 includes a microphone unit coder/decoder 20, a digital signal processor 22, an adaptive noise reducer 24, sound processing software 26, a microphone unit transmitter 28 and a microphone unit battery 30.

The coder/decoder 20 receives analog signals from the microphone 14, and translates the audio signals to digital signals for processing. The coder/decoder 20 preferably has 20 bit audio precision, a 95 dB input dynamic range with a headroom expander, and an 88 dB output dynamic range. The headroom expander significantly extends the dynamic range of the A/D conversion performed by the coder/decoder 20, which is very important for high-fidelity audio signal processing. A suitable headroom expander for use with the coder/decoder 20 is described in U.S. Pat. No. 6,937,738, assigned to Gennum Corporation of Burlington, Canada, incorporated herein by reference. It should be appreciated that the specifications of the coder/decoder 20, as well as that of the other components mentioned herein, may vary depending on the particular application or market, and as new technology is developed.

The digital signal processor 22 preferably performs baseband processing functions on digital audio signals received from the coder/decoder 20, such as, for example, audio compression, encoding, data formatting, framing and directional processing. The digital signal processor 22 preferably has an audio sample rate of 32 KHz, a 20 bit end-to-end audio path and a 16 KHz bandwidth. An example of a digital signal processor suitable for use with the present invention is the Voyaguer™ platform, available from Gennum Corporation.

The adaptive noise reducer 24 performs further processing on the digital audio signals received from the coder/decoder 20 to minimize distortion. Preferably, the adaptive noise reducer 24 uses perceptual models of the human auditory system to automatically adjust the degree of noise reduction to the level and type of ambient noise. An example of such an adaptive noise reducer is the Duet™ platform, also available from Gennum Corporation. Alternatively, the adaptive noise reducer 24 may use sound sampling and cancellation technology to reduce or eliminate unwanted noise. For example, the adaptive noise reducer may sample unwanted environmental noise, such as background voices in a crowded restaurant, and cancel such noise so that the user only hears the desired voice and/or sounds.

The sound processing software 26 allows a user to modify the digital audio signals as desired to maximize perceived effectiveness of the hearing assist device 1. The sound processing software may include a frequency control circuit 23, a balance control circuit 25 and a volume control circuit 27. According to at least one embodiment of the present invention, the sound processing software 26 includes 4 channel wide dynamic range compression and a 4 band graphic equalizer with 24 dB gain in each band. The user controls, such as the volume control 16, the graphic equalizer 18 and the balance control 20 are operatively associated with the sound processing software 26 to allow the user to adjust the audio signals. In particular, the graphic equalizer 18 allows the user to shape the frequency response profile. Shaping the frequency response is important for users whose natural response is non-uniform. For example, low user sensitivity at high frequencies requires higher system gain at high frequencies.

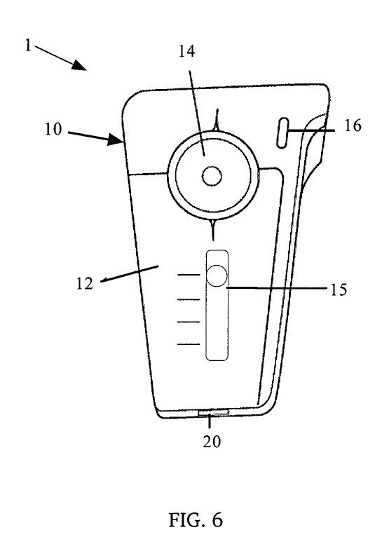

As shown in FIG. 6, according to another exemplary embodiment, the microphone unit 10 may include a frequency control switch 15 that allows a user to toggle between two or more, and preferably at least four, pre-programmed frequency response profiles. Thus, the user is able to select, depending on the chosen position of the switch, whether to emphasize high, low or medium frequencies to enhance hearing in varying environments. Although FIG. 6 shows the frequency control switch 15 being used in place of the graphic equalizer 18, it should be appreciated that the switch 15 may also be used in addition to the graphic equalizer 18. In another embodiment of the invention, a single switch may be associated with each pre-programmed frequency response profile, so that a user may select and de-select any combination of the switches to achieve the desired frequency profile.

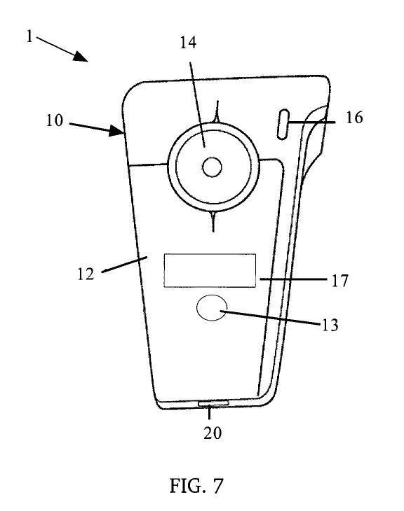

As shown in FIG. 7, instead of a frequency control switch, a single button 13 along with a display, such as LCD display 17, may be used to allow a user to control the setting of the pre-programmed frequency response profile. The display may indicate which pre-programmed response profile is currently selected, and pressing of the button may change the currently selected profile to another profile.

The transmitter 28 receives and converts the fully processed digital audio data to an RF communication protocol for transmission to the microphone unit 10. The transmitter 28 preferably has an operating frequency between 720-928 MHz, 16 bit audio precision, <10 msec latency, Gaussian minimum shift keying (GMSK) modulation, automatic channel selection and frequency hopping for interference-free communication and privacy, and peak power consumption of 4 mW. The transmitter 28 preferably has a six foot range, although other ranges are within the scope of the present invention. An example of a suitable transmitter useable with the present invention is the Falcon™ wireless system, available from Gennum Corporation.

The battery 30 may be, for example, a NiMH rechargeable battery or AAA alkaline replaceable battery. The microphone unit 10 may also be configured to be powered by an electrical power outlet.

The microphone unit 10 may also include a jack (not shown) for receipt of an input from an electronic device, such as, for example, a television, a cell phone, or a radio. The user may then manipulate the controls on the microphone unit 10 so as to better hear the electronic device.

FIG. 4 is a block diagram illustrating the internal components of the receiver unit 40. The receiver unit 40 includes a receiver 52, a receiver unit coder/decoder 54, the speaker 44 and a receiver unit battery 56. The receiver 52 receives the RF signals from the microphone unit 10, and translates the RF signals to digital audio signals. The coder/decoder 54 then translates the digital audio signals to analog signals. The speaker 44 receives the analog signals and generates sound waves based on the analog signals within the ear canal of the user. The coder/decoder 54 and receiver 52 may have the same specifications as the coder/decoder 20 and transmitter 28 used in the microphone unit 10. The battery 56 may be a NiMH rechargeable battery or a Zn-air battery replaceable battery.

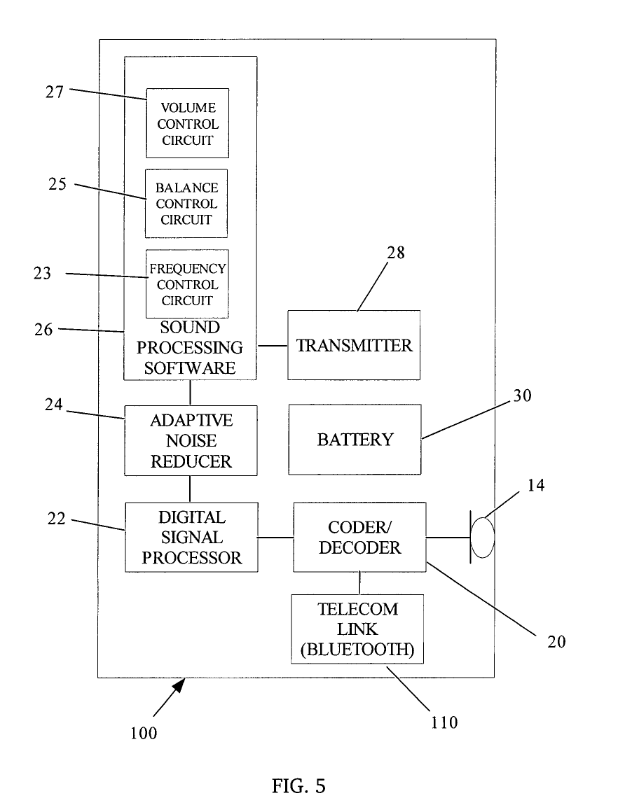

FIG. 5 is a block diagram illustrating a microphone unit, generally designated by reference number 100, according to another exemplary embodiment of the present invention. The microphone unit 100 has the same components as the microphone unit 10 according to the previous embodiment, in addition to a second RF telecommunications link for communication with an external device or network, such as a computer network, a CD player, a television or a cellular phone. In particular, according the present embodiment, the microphone unit 100 includes a Bluetooth enabled telecommunications link 110. A Bluetooth link advantageously has an identification code for each device incorporated into its protocol. Thus, the microphone unit 100 may connect with all known or later developed Bluetooth audio devices, and is preferably configured to pair with up to three Bluetooth devices. The battery 30 used in this embodiment may be a lithium ion polymer rechargeable battery.

The microphone unit 100 also preferably includes an accept/reject switch that allows a user to accept or reject a Bluetooth audio link. For example, if the microphone unit 100 is paired and connected to a Bluetooth-enabled cell phone and is being used in the remote microphone mode, when an incoming call arrives, the microphone unit 100 will produce a ring tone in the receiver unit 40. The user can then opt to accept the call by switching the call accept/reject switch on the microphone unit 100 to the accept position. The call can be terminated by switching the call accept/reject switch back to the reject position. Thus, no manipulation of the cell phone is required.

The hearing assist device according to various exemplary embodiments of the present invention may also be used in conjunction with a conventional hearing aid to enhance the function of the hearing aid. For example, the receiver unit 40 may be placed in one ear of a user, and an ear piece of a hearing aid may be placed in the other ear. The user may then adjust the hearing assist device 1 as the user enters different sound environments to improve the effect of the hearing aid.

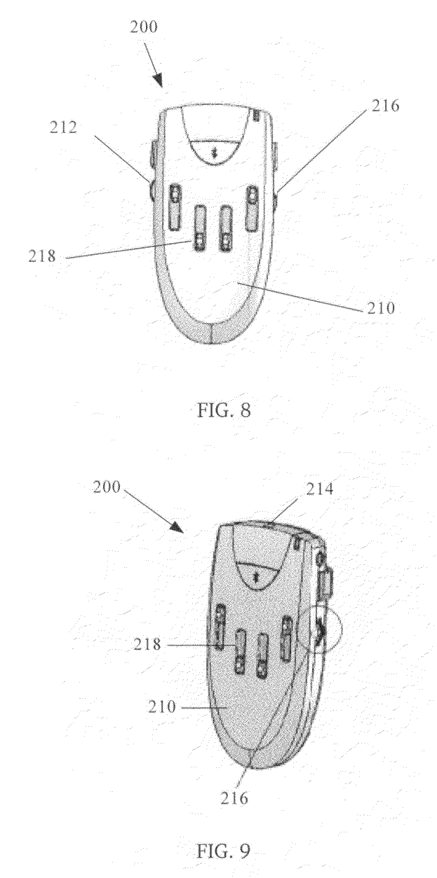

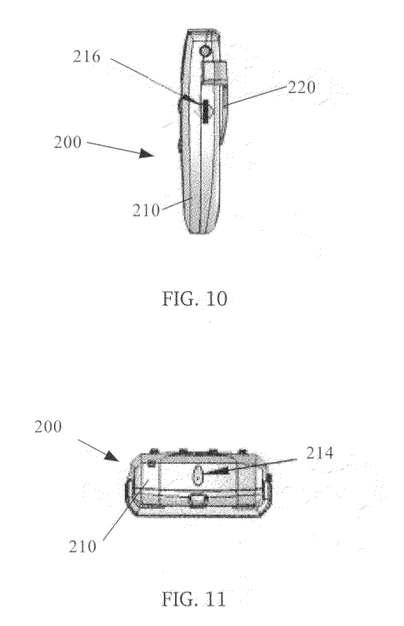

FIG. 8 is a plan view of a microphone unit, generally designated by reference number 200, according to another exemplary embodiment of the present invention; FIG. 9 is a perspective view of the microphone unit 200; FIG. 10 is a side view of the microphone unit 200; and FIG. 11 is a top view of the microphone unit 200. As in the previous embodiments, the microphone unit 200 includes an outer casing 210, a microphone 214 disposed at the top portion of the microphone unit 200, and a variety of controls, such as on/off switch 212, volume control switch 214, and graphic equalizer 218. Also, as shown in FIG. 10, the microphone unit 200 includes a clip 220 that may be used to attach the microphone unit 200 to a user's belt, for example, or to some other object. The microphone unit 200 may include the same internal components as those described with reference to previous embodiments.

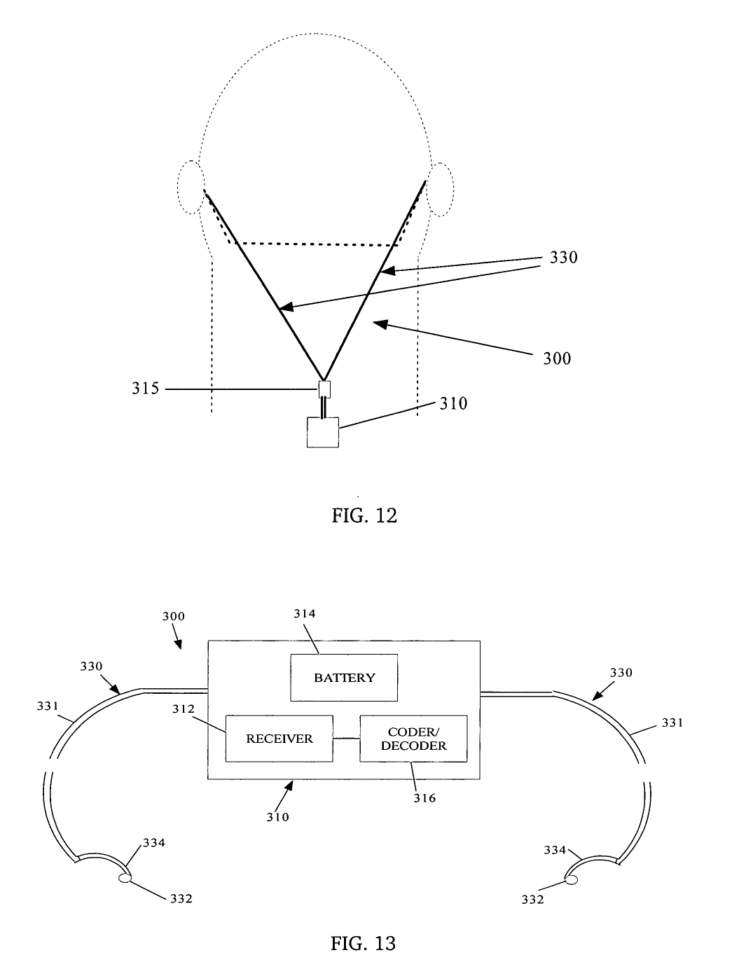

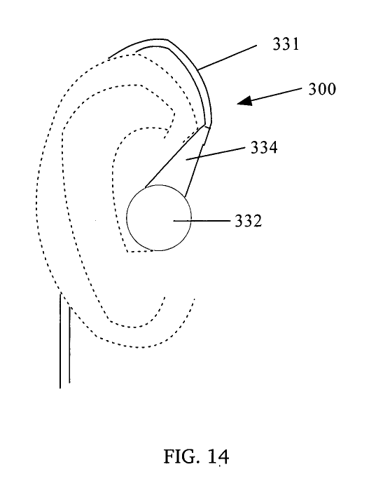

FIG. 12 shows a receiver unit 300, useable with the microphone unit 200, attached to a user's head; FIG. 13 is a block diagram of the receiver unit 300; and FIG. 14 shows a portion of the receiver unit 300 attached to a user's ear. The receiver unit 300 of the present embodiment differs from previous embodiments in that the speakers are separate from the other components of the receiver unit 300. In particular, the receiver unit 300 includes a receiver unit main component 310 and separate speaker units 330. The receiver unit preferably includes two speaker units 330, one for each ear of the user. Each speaker unit 330 includes an ear bud 332, a strain relief section 334, and a conductive wire 331 that electrically connects the ear bud 334 to the receiver unit main component 310. The ear bud 332 may be shaped appropriately to fit within the ear, and includes a speaker (not shown) for the generation of sound within the ear based on the signals received by the receiver unit 300 from the microphone unit 200. The strain relief section 334 provides a more secure attachment between the wire 331 and ear bud 332, and is preferably made of a stiffer (but preferably still bendable) material than the wire 331 so that it may be used to effectively attach the ear bud 332 to the user's ear.

As shown in FIGS. 12 and 14, the receiver unit 300 may be worn behind the neck of the user by first attaching the ear buds 332 so that the wires 331 extend from behind the user's ears. A slidable locking piece 315 may be used to adjust the separation between the wires 331, so that the receiver unit 300 may fit more snug around the user's head and neck, if desired. The receiver unit main component 310 may then be rotated around the user's head so that the main component 310 hangs behind the user's neck or on the user's back, hidden from view beneath clothing, if desired.

As shown in FIG. 13, the receiver unit main component 310 includes a receiver 312, a battery 314 and a coder/decoder 316. Each of these components may perform functions as described with reference to previous embodiments. Alternatively, the wires 331 may function as antennae for receiving RF signals from the microphone unit 10, thereby obviating the need for the receiver 312 within the receiver unit main component 310.

While the foregoing invention has been described in some detail for purposes of clarity and understanding, it will be appreciated by one skilled in the art from a reading of the disclosure that various changes in form and detail can be made without departing from the true scope of the invention in the appended claims.

What is claimed is:

1. A wireless hearing assist device comprising:
a microphone unit comprising:
a microphone that receives audio signals from multiple sources;
a frequency profile adjustment control circuit that adjusts frequency profile of the received audio signals based on input by a user; and
a transmitter that wirelessly transmits the adjusted audio signals; and
a receiver unit adapted to be worn by the user, comprising:
a receiver that wirelessly receives the adjusted audio signals transmitted by the transmitter; and
at least one speaker that generates sound based on the adjusted audio signals.

2. The wireless hearing assist device of claim 1, further comprising a graphic equalizer that allows the user to select input to the frequency profile adjustment control circuit to adjust the frequency profile.

3. The wireless hearing assist device of claim 1, further comprising a switch that allows a user to send input to the frequency profile adjustment control circuit to adjust the frequency profile to two or more different pre-programmed frequency profiles.

4. The wireless hearing assist device of claim 1, wherein the microphone unit further comprises a volume control circuit that adjusts amplification of the audio signals based on input by the user.

5. The wireless hearing assist device of claim 1, wherein the receiver unit comprises two speakers, and the microphone unit further comprises a balance control circuit that adjusts gain between the two speakers.

6. The wireless hearing assist device of claim 1, wherein the receiver unit includes a housing that is at least partially flexible.

7. The wireless hearing assist device of claim 1, wherein the microphone unit further includes a battery.

8. The wireless hearing assist device of claim 1, wherein the receiver unit further includes a battery.

9. The wireless hearing assist device of claim 1, wherein the microphone unit further comprises an adaptive noise reducer that minimizes distortion of sound produced by the audio signals.

10. The wireless hearing assist device of claim 1, wherein the microphone unit further comprises a digital signal processor that processes the audio signals.

11. The wireless hearing assist device of claim 1, wherein the microphone unit comprises an RF communication link for wireless communication with an external device other than the receiver unit.

12. The wireless hearing assist device of claim 11, wherein the RF communication link to the external device other than the receiver unit is Bluetooth enabled.

13. The wireless hearing assist device of claim 1, wherein the transmitter has a limited range.

14. The wireless hearing assist device of claim 8, wherein the receiver unit comprises:
a receiver unit main component;
at least one ear bud adapted to be worn at the ear of the user, the ear bud including the at least one speaker; and
a conductive wire that electrically connects the receiver main component to the at least one ear bud.

15. The wireless hearing assist device of claim 14, wherein the receiver is disposed within the receiver unit main component.

16. The wireless hearing assist device of claim 14, wherein the battery is disposed within the receiver unit main component.

17. The wireless hearing assist device of claim 14, wherein the receiver includes the conductive wire.

18. A wireless hearing assist device comprising:
a microphone unit comprising:
a microphone that receives audio signals from multiple sources;
a transmitter that wirelessly transmits the audio signals; and
a Bluetooth enabled RF communication link for wireless communication with a device external to the wireless hearing assist device; and
a receiver unit adapted to be worn by the user, comprising:
a receiver that wirelessly receives the audio signals transmitted by the transmitter; and
at least one speaker that generates sound based on the audio signals.

19. The wireless hearing assist device of claim 18, wherein the external device is at least one of the following: a cellular phone, a compact disc player, a television and a computer.
